(19) United States
(12) Patent Application Publication
(10) Pub. No.: US 2018/0001441 A1
(43) Pub. Date: Jan. 4, 2018

(54) Abrasive Articles with Removable Abrasive Member and Methods of Separating and Replacing Thereof

(71) Applicant: 3M INNOVATIVE PROPERTIES COMPANY, St. Paul, MN (US)

(72) Inventors: Kelvin Sze Wei Ang, Singapore (SG); Kok Chian Loh, Singapore (SG); Jeffrey S. Kollodge, Stillwater, MN (US)

(21) Appl. No.: 15/537,970

(22) PCT Filed: Dec. 15, 2015
(86) PCT No.: PCT/US2015/065772

§ 371 Date: Jun. 20, 2017

Related U.S. Application Data
(60) Provisional application No. 62/095,090, filed on Dec. 22, 2014.

(51) Int. Cl. B24B 53/017; B24B 37/22; B24D 3/00; B24B 37/14; B24D 9/08; B24D 13/20; B24D 7/16; C04B 35/638; C04B 35/573

(52) U.S. Cl. CPC B24B 53/017; B24D 13/20; B24B 37/22; B24D 3/007; B24D 7/16; B24B 37/14; B24D 9/085; C04B 35/573; C04B 35/638; C04B 2235/427; C04B 2235/483

(57) ABSTRACT

The present disclosure relates to abrasive articles including an abrasive member having opposing major surfaces, a working surface and an exterior attachment surface, wherein the abrasive member comprises an inorganic material having a Mohs hardness greater than about 7.0; and a magnetic member, having opposing first and second major surfaces and a corresponding magnetic force, wherein the first major surface of the magnetic member faces the exterior attachment surface. The abrasive articles of the present disclosure may include a third member. The third member is attached to the magnetic member by a magnetic force. The abrasive member with attached magnetic member is designed to be easily removed from the third member. Methods of separating an abrasive member from an abrasive article and replacing the abrasive member of an abrasive article are also provided.

### FIELD

The present disclosure generally relates to abrasive articles. In particular, the present disclosure relates to abrasive articles that allow for easy separation of components therein so that a support substrate may be recovered and reused. The disclosure further provides methods of separating an abrasive member from an abrasive article and methods of replacing the abrasive member of an abrasive article.

### BACKGROUND

Various abrasive articles have been introduced with separable components. Such abrasive articles are described in, for example, G.B. Pat. No. 1,058,502 and U.S. Pat. No. 4,222,204.

### SUMMARY

Abrasive articles find utility in a variety of applications including, for example, lapping films useful for ceramic and metal finishing, sintered abrasive articles, e.g. pad conditioners, useful for conditioning polishing pads used in chemical mechanical planarization (CMP) applications and structured abrasives useful for glass and sapphire grinding and polishing. Typically, the abrasive article has an abrasive member that includes a working surface that may include at least one of abrasive particles and abrasive coating. The working surface may also include a structured abrasive that includes at least one of abrasive particles and abrasive coating. In some applications, the abrasive article is supported by a support substrate, also referred to as a third member, herein. The support substrate may be fabricated from polymeric or metal materials. Often, once the working surface of the abrasive article is dulled or worn due to use and no longer functions as required, the abrasive article is discarded and replaced by a new abrasive article having a fresh working surface. When discarding the abrasive article, the support substrate is also discarded, even though it may still function as required for the application. If the support substrate is expensive; due to at least one of fabrication and material cost, for example a machined stainless steel carrier used to support the sintered abrasive plate of a pad conditioner; this can lead to an increase in cost of the abrasive article. Thus, it is desired to provide an abrasive article wherein the abrasive member that contains the working surface can be easily separated from the support substrate, so that a new abrasive member with a fresh working surface can be replaced on the support substrate. In so doing, the support substrate is recovered and reused at considerable cost savings. The present disclosure provides abrasive articles that allow for easy separation of the abrasive member from a support substrate, through the use of magnetic attachment, such that the support substrate can be recovered and reused. The abrasive articles of the present disclosure allow a wide variety of abrasive members fabricated from a large variety of materials, particularly materials that are non-responsive to a magnetic field, e.g. non-ferromagentic materials, to be magnetically coupled to a third member, e.g. a support substrate. The abrasive articles of the present disclosure may find particular utility as pad conditioners, useful, for examples, in CMP applications. The disclosure further provides methods of separating an abrasive member from an abrasive article and methods of replacing the abrasive member of an abrasive article.

In one aspect, the present disclosure provides an abrasive article comprising:

an abrasive member having a working surface and an exterior attachment surface disposed opposite the working surface, wherein the abrasive member comprises a matrix material and an inorganic material having a Mohs hardness greater than about 7.0; and

a magnetic member having opposing first and second major surfaces;

wherein the first major surface of the magnetic member faces the exterior attachment surface; and

wherein the region of the abrasive article between the working surface of the abrasive member and first major surface of the magnetic member is free of a coupling structure that couples the abrasive member to the magnetic member by a magnetic force.

In another aspect, the present disclosure provides an abrasive article comprising:

an abrasive member having a working surface and an exterior attachment surface disposed opposite the working surface, wherein the abrasive member comprises a matrix material and an inorganic material having a Mohs hardness greater than about 7.0; and

a magnetic member having opposing first and second major surfaces;

wherein the first major surface of the magnetic member faces the exterior attachment surface;

wherein the region of the abrasive article between the working surface of the abrasive member and first major surface of the magnetic member is free of a coupling structure that couples the abrasive member to the magnetic member by a magnetic force; and

a third member having a first major surface and a second major surface, wherein the first major surface of the third member faces the second major surface of the magnetic member and wherein the third member comprises a ferromagnetic material and is attached to the magnetic member by a magnetic force.

In another aspect, the present disclosure provides a method of separating an abrasive member from an abrasive article comprising:
providing an abrasive article comprising;
   an abrasive member having a working surface and an exterior attachment surface disposed opposite the working surface, wherein the abrasive member comprises a matrix material and an inorganic material having a Mohs hardness greater than about 7.0; and a magnetic member having opposing first and second major surfaces;
wherein the first major surface of the magnetic member faces the exterior attachment surface;
   wherein the region of the abrasive article between the working surface of the abrasive member and first major surface of the magnetic member is free of a coupling structure that couples the abrasive member to the magnetic member by a magnetic force; and
   a third member having a first major surface and a second major surface, wherein the first major surface of the third member faces the second major surface of the magnetic member and wherein the third member comprises a ferromagnetic material and is attached to the magnetic member by a magnetic force; and

applying a separating force to at least one of the abrasive member, the magnetic member and the third member, wherein the separating force exceeds the magnetic force between the magnetic member and third member causing the abrasive member and attached magnetic member to separate from the third member.

In another aspect, the present disclosure provides method of replacing the abrasive member of an abrasive article comprising:
providing an abrasive article comprising;
   an abrasive member having a working surface and an exterior attachment surface disposed opposite the working surface, wherein the abrasive member comprises a matrix material and an inorganic material having a Mohs hardness greater than about 7.0; and a magnetic member having opposing first and second major surfaces;
wherein the first major surface of the magnetic member faces the exterior attachment surface;
   wherein the region of the abrasive article between the working surface of the abrasive member and first major surface of the magnetic member is free of a coupling structure that couples the abrasive member to the magnetic member by a magnetic force; and
   a third member having a first major surface and a second major surface, wherein the first major surface of the third member faces the second major surface of the magnetic member and wherein the third member comprises a ferromagnetic material and is attached to the magnetic member by a magnetic force,

applying a separating force to at least one of the abrasive member, the magnetic member and the third member, wherein the separating force exceeds the magnetic force between the magnetic member and third member causing the abrasive member and attached magnetic member to separate from the third member,
providing a second abrasive article comprising;
   an abrasive member having a working surface and an exterior attachment surface disposed opposite the working surface, wherein the abrasive member comprises a matrix material and an inorganic material having a Mohs hardness greater than about 7.0; and a magnetic member having opposing first and second major surfaces;
wherein the first major surface of the magnetic member faces the exterior attachment surface; and
   wherein the region of the abrasive article between the working surface of the abrasive member and first major surface of the magnetic member is free of a coupling structure that couples the abrasive member to the magnetic member by a magnetic force,

positioning the second abrasive article such that the second major surface of the magnetic member of the second abrasive article is proximate to and faces the first major surface of the third member; and

attaching the magnetic member of the second abrasive article to the third member by a magnetic force.

The abrasive articles of the present disclosure may further include an adhesive member interposed between and in contact with the exterior attachment surface of the abrasive member and first major surface of the magnetic member.

### BRIEF DESCRIPTION OF THE DRAWINGS

FIG. 1A is a schematic cross-sectional side view of an exemplary abrasive article according to one exemplary embodiment of the present disclosure.

FIG. 1B is a schematic cross-sectional side view of cut-out 190 of an exemplary embodiment of the abrasive article of FIG. 1A of the present disclosure.

FIG. 1C is a schematic cross-sectional side view of cut-out 190 of an exemplary embodiment of the abrasive article of FIG. 1A of the present disclosure.

FIG. 1D is a schematic cross-sectional side view of cut-out 190 of an exemplary embodiment of the abrasive article of FIG. 1A of the present disclosure.

FIG. 1E is a schematic top view of an exemplary embodiment of the abrasive article of FIG. 1A of the present disclosure.

FIG. 1F is a schematic top view of an exemplary embodiment of the abrasive article of FIG. 1A of the present disclosure.

FIG. 1G is a schematic cross-sectional side view of cut-out 190 of an exemplary embodiment of the abrasive article of FIG. 1A of the present disclosure.

FIG. 1H is a schematic cross-sectional side view of cut-out 190 of an exemplary embodiment of the abrasive article of FIG. 1A of the present disclosure.

FIG. 1I is a schematic cross-sectional side view of cut-out 190 of an exemplary embodiment of the abrasive article of FIG. 1A of the present disclosure.

FIG. 1J is a schematic cross-sectional side view of cut-out 190 of an exemplary embodiment of the abrasive article of FIG. 1A of the present disclosure.

FIG. 2 is a schematic cross-sectional side view of an exemplary abrasive article according to one exemplary embodiment of the present disclosure.

FIG. 3A is a schematic cross-sectional side view of an exemplary abrasive article according to one exemplary embodiment of the present disclosure.

FIG. 3B is a schematic cross-sectional side view of an exemplary abrasive article according to one exemplary embodiment of the present disclosure.

FIG. 4A is a schematic cross-sectional side view of an exemplary abrasive article according to one exemplary embodiment of the present disclosure.

FIG. 4B is a schematic cross-sectional side view of an exemplary abrasive article according to one exemplary embodiment of the present disclosure.

FIG. 4C is a schematic cross-sectional side view of an exemplary abrasive article according to one exemplary embodiment of the present disclosure.

FIG. 4D is a schematic cross-sectional side view of an exemplary abrasive article according to one exemplary embodiment of the present disclosure.

FIG. 4E is a schematic cross-sectional side view of an exemplary abrasive article according to one exemplary embodiment of the present disclosure.

FIG. 4F is a schematic cross-sectional side view of an exemplary abrasive article according to one exemplary embodiment of the present disclosure.

FIG. 5A is a schematic cross-sectional side view of an exemplary abrasive article according to one exemplary embodiment of the present disclosure.

FIG. 5B is a schematic cross-sectional side view of an exemplary abrasive article according to one exemplary embodiment of the present disclosure.

FIG. 6A-6D is an exemplary method of separating and replacing an abrasive member according to one exemplary embodiment of the present disclosure, as viewed by schematic cross-sectional side views of exemplary abrasive articles of the present disclosure.

FIG. 7 is a schematic cross-sectional side view of an exemplary abrasive article according to one exemplary embodiment of the present disclosure.

FIG. 8 is a schematic cross-sectional side view of an exemplary abrasive article according to one exemplary embodiment of the present disclosure.

FIG. 9A is a schematic cross-sectional side view of an exemplary abrasive article according to one exemplary embodiment of the present disclosure.

FIG. 9B is a schematic cross-sectional side view of an exemplary abrasive article according to one exemplary embodiment of the present disclosure.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this disclosure, if one surface is in contact with another surface, the two surfaces are, inherently, facing each other.

“Working surface” refers to the surface of an abrasive member or abrasive article that will be adjacent to and in at least partial contact with the surface of the substrate being abraded.

### DETAILED DESCRIPTION

The abrasive articles according to the present disclosure include an abrasive member having a working surface and an exterior attachment surface disposed opposite the working surface, wherein the abrasive member comprises a matrix material and an inorganic material having a Mohs hardness greater than about 7.0; and a magnetic member having opposing first and second major surfaces; wherein the first major surface of the magnetic member faces the exterior attachment surface. In some embodiments, the region of the abrasive article between the working surface of the abrasive member and first major surface of the magnetic member is free of a coupling structure that couples the abrasive member to the magnetic member by a magnetic force. In some embodiments, the magnetic member is coupled to abrasive member by a non-magnetic force. In some embodiments, the region of the abrasive article between the working surface of the abrasive member and first major surface of the magnetic member is free of a coupling structure that couples the abrasive member to the magnetic member by a magnetic force and the magnetic member is coupled to abrasive member by a non-magnetic force. By “couples” it is meant that the abrasive member is attached to the magnetic member, such that, when the abrasive member is positioned with its working surface facing downward or perpendicular to the ground, the coupling force, e.g. a magnetic force or a non-magnetic force, is greater than the force of gravity acting on the abrasive member and the abrasive member does not separate from the magnetic member or change its position relative to the magnetic member. The abrasive member is limited in that only one of its opposing major surfaces is a working surface, i.e., a surface specifically designed to abrade a substrate, the other is an exterior attachment surface adapted to provide a surface to which the magnetic member may be affixed. The exterior attachment surface of the abrasive member may be substantially planar.

The abrasive members of the present disclosure include an inorganic material having a Mohs hardness greater than about 7.0. The inorganic material may be in the form of inorganic particles or an inorganic coating. In some embodiments, the inorganic material may have a Mohs hardness greater than about 7.0, greater than about 7.5, greater than about 8.0, greater than about 8.5, greater than about 9.0, or even greater than about 9.5. In some embodiments, the inorganic material may have a Mohs hardness of about 10 or less. The inorganic material may have a Mohs hardness between about 7.0 and about 10, between about 7.5 and about 10 between about 8.0 and about 10, between about 8.5 and about 10 or even between about 9.0 and about 10. As the Mohs hardness is a relative scale, with 10 being the maximum value and generally related to diamond, any material having a hardness greater than diamond, e.g. ultra-hard fullerite, rhenium diboride, and nanocrystaline diamond including aggregated diamond nanorods, is designated to have a Mohs hardness of 10. In some embodiments, the inorganic material includes, but is not limited to, at least one of garnet, zirconia, spinel, zirconium silicate, chromium, silicon nitride, tantalum carbide, aluminum oxide, silicon carbide, tungsten carbide, titanium carbide, boron, boron nitride, boron carbide, rhenium diboride, titanium diboride, diamond, diamond like carbon, ultra-hard fullerite, rhenium diboride, and nanocrystaline diamond including aggregated diamond nanorods. Combinations of two or more inorganic materials may be used, including combinations of two or more inorganic particles, e.g. abrasive particles. The inorganic material does not act as a coupling structure that couples the abrasive member to the magnetic member by a magnetic force. Although the inorganic material does not act as a coupling structure that couples the abrasive member to the magnetic member by a magnetic force, in some embodiments the inorganic material may contain small quantities of ferromagnetic material as an impurity or additive; less than 20%, less than 10%, less than 5%, less than 3%, less than 1% by weight ferromagnetic material or even no ferromagnetic material. In some embodiments, the inorganic material is non-ferromagnetic.

The matrix material may be a metal, a polymer, a ceramic, e.g. a green body ceramic or sintered ceramic or combinations thereof. The matrix material may include various additives and fillers known in the art. In some embodiments, the matrix material may not include ferromagnetic material. In some embodiments, the matrix material may include ferromagnetic material. In these embodiments, the type and amount of ferromagnetic material is selected such that the matrix material does not act as a coupling structure that couples the abrasive member to the magnetic member by a magnetic force. In some embodiments, the matrix material contains less than about 50%, less than about 40%, less than about 30%, less than about 20%, less than about 10%, less than about 5%, less than 3% by weight ferromagnetic material or even no ferromagnetic material.

The abrasive articles of the present disclosure may include an adhesive member interposed between and in contact with the exterior attachment surface of the abrasive member and the first major surface of the magnetic member. The adhesive member adheres the abrasive member to the magnetic member. The magnetic member may, optionally, be permanently affixed to the abrasive member.

The abrasive articles of the present disclosure may include a third member. In some embodiments, the third member is free of a shaft, e.g. a drive shaft, suitable for driving or rotating the abrasive article during use.

The abrasive articles of the present disclosure may include one or more optional alignment cavities and/or one or more optional alignment pins.

The abrasive articles of the present disclosure may include one or more optional release mechanisms. The release mechanism may include one or more release cavities, one or more release edge grooves and/or one or more release tabs. In some embodiments, the abrasive member of the abrasive article is free of a hub structure as a means for driving the abrasive member and as a means for locking the abrasive member to a socket member.

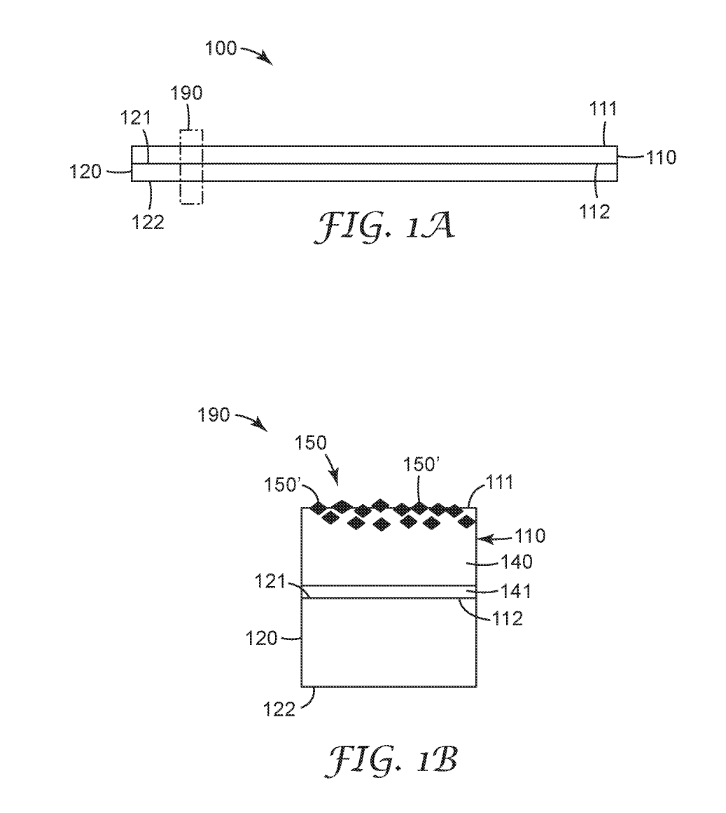

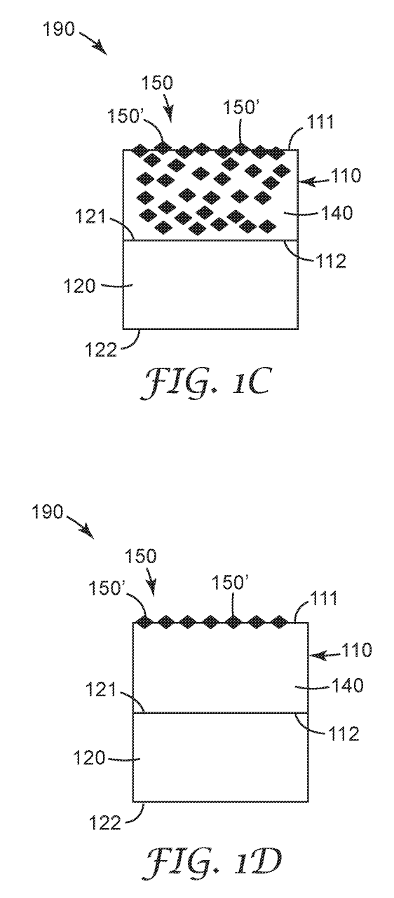

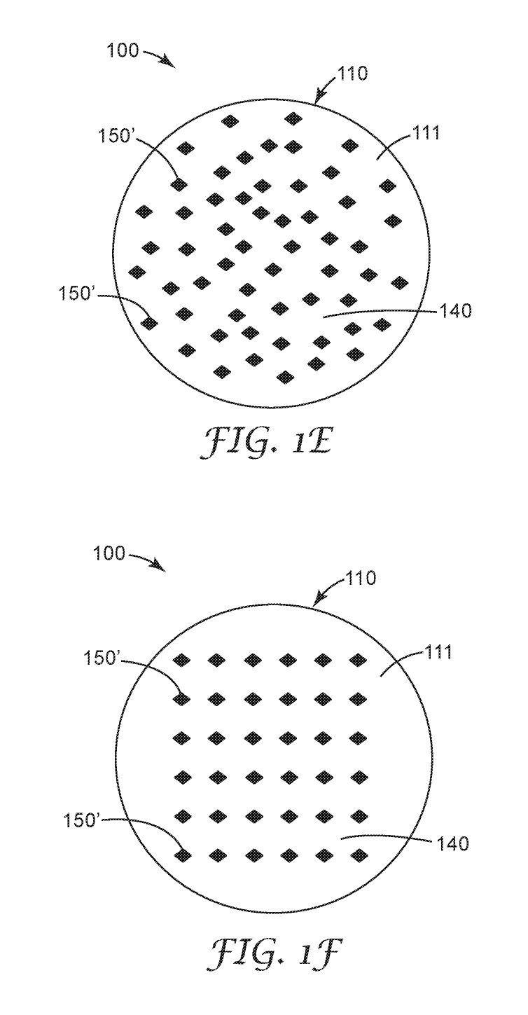

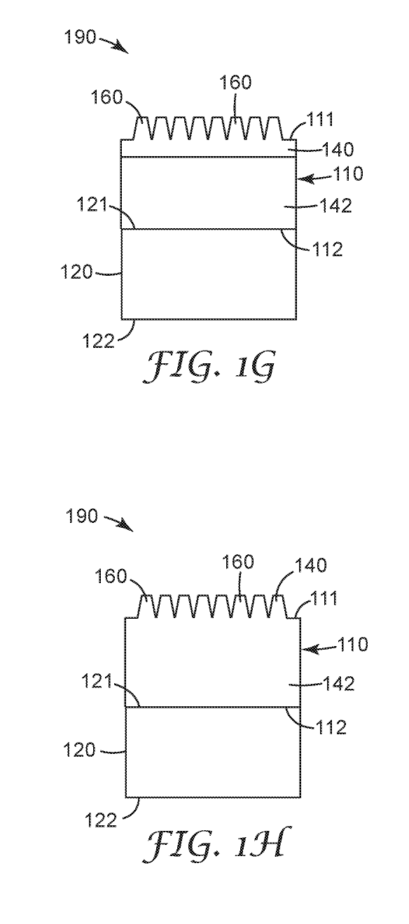

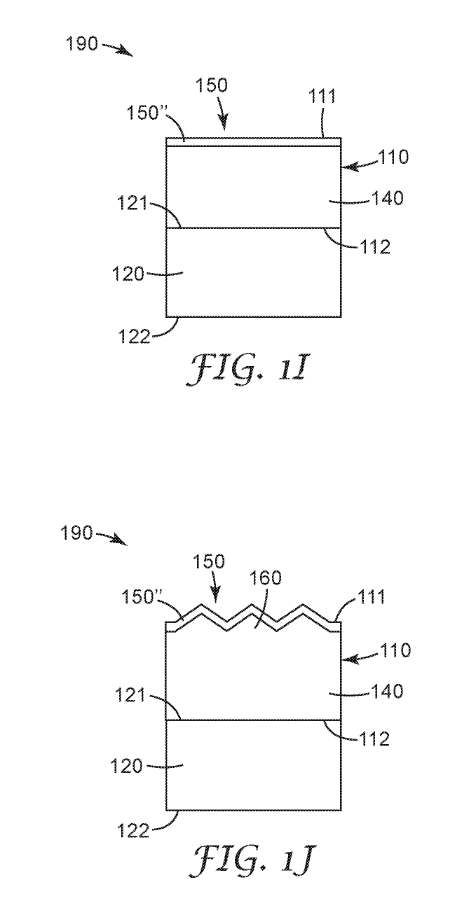

Several specific, but non-limiting, embodiments are shown in FIGS. 1A-1J, FIG. 2, FIGS. 3A and 3B, FIGS. 4A-4F, FIGS. 5A and 5B, FIG. 7, FIG. 8 and FIGS. 9A and 9B.

Referring now to FIG.1A, abrasive article 100 includes abrasive member 110 having opposing major surfaces which include working surface 111 and exterior attachment surface 112, and a magnetic member 120, having opposing first major surface 121 and second major surface 122, wherein first major surface 121of magnetic member 120 faces exterior attachment surface 112. Abrasive member 110 includes an inorganic material having a Mohs hardness greater than about 7.0 (not shown). The region between the working surface 111 of the abrasive member 110 and first major surface 121 of the magnetic member 120 is free of a coupling structure that couples the abrasive member to the magnetic member by magnetic force. By “coupling structure” it is meant a fabricated article. The coupling structure may include a plate, hub, magnets, e.g. permanent magnets or the like, more particularly a metal plate, metal hub or permanent magnets. The coupling structure may include a ferromagnetic material that is not a permanent magnetic itself but responds to a magnetic field. Beside the limitation that the abrasive member has only one major surface that is a working surface, the abrasive member can include a variety of abrasive materials known in the art, including, but not limited to, coated abrasives, nonwoven abrasives, bonded abrasives, precisely shaped abrasives, i.e. abrasives with precisely shaped features or structures, and sintered abrasives.

FIG. 1B shows one embodiment of cut-out 190 of FIG. 1A in more detail. FIG. 1B includes abrasive member 110 having opposing major surfaces which include working surface 111 and exterior attachment surface 112, and a magnetic member 120, having opposing first major surface 121 and second major surfaces 122. Abrasive member 110 further includes matrix material 140 and an inorganic material 150 in the form of abrasive particles 150′. Abrasive particles 150′ are concentrated near working surface 111, as would be found in, for example, a conventional coated abrasive article or a metal bond abrasive article. Abrasive member 110 includes working surface 111 with abrasive particles 150′ protruding from matrix material 140 at working surface 111. The matrix material affixes the abrasive particles to the abrasive member. In some embodiments, the inorganic material comprises abrasive particles that are at least partially contained in a portion of the matrix material that is proximate the working surface. A conventional dressing process may be used to initially expose the abrasive particles at working surface 111, prior to use, or the abrading process itself may initially expose the abrasive particles at the beginning of use. During use, wear of the abrasive member may expose new abrasive particles on working surface 111, refreshing the abrading ability of working surface 111. Additionally, working surface 111 may be periodically dressed, during use, exposing new abrasive particles. Abrasive member 110 may also include one or more optional backings 141. In some embodiments, the backings would include exterior attachment surface 112. Backing 141 may be non-ferromagnetic.

In a conventional coated abrasive article, matrix material 140 may include one or more make coats and one or more size coats. The make and size coats are typically polymeric in nature and may be thermoplastic resins; including, but not limited to, polyesters, polyamides, polyolefin, polyacrylate and combinations thereof; and thermosetting resins, including, but not limited to, phenolic resins, aminoplast resins, urethane resins, epoxy resins, acrylic resins, acrylated isocyanurate resins, cyanate resins, urea-formaldehyde resins, isocyanurate resins, acrylated urethane resins, acrylated epoxy resins, glue, and combinations thereof. Matrix material 140 may coat the exterior surface of abrasive particles 150′ located at working surface 111. Backing 141 may include, but is not limited to, paper backings, woven and nonwoven backings, plastic backings, metal backings and the like. In some embodiments, the optional backing may be non-ferromagnetic.

In a metal bond abrasive article, matrix material 140 may include a metal, including, but not limited to, nickel, copper, silver, brass, bronze, steel and alloys thereof. Backing 141 for metal bond abrasive articles may include, but is not limited to, metals, metal alloys, metal-matrix composites, metalized plastics or polymer matrix reinforced composites. In some embodiments, the optional backing may be non-ferromagnetic.

Although matrix material 140 is shown to be significantly thicker than the region containing abrasive particles 150, the thickness of matrix material 140 may vary according to the desired design of the abrasive article. In some embodiments, the thickness of matrix material 140 may be greater than about 5%, greater than about 10%, greater than about 20%, greater than about 50%, greater than about 100%, greater than about 200% or even greater than 300% the average particles size of abrasive particle 150′. In some embodiments, the thickness of matrix material 140 may be less than about 1,000%, less than about 800%, less than about 600%, less than about 400% or even less than 100% the average particles size of abrasive particle 150′. Abrasive particle size can be measured by known techniques in the art, including light scattering, which may yield an average particle size based on the particle volume.

FIG. 1C shows another embodiment of cut-out 190 of FIG 1A in more detail. The description of the elements in FIG. 1C are identical to the description of the elements of FIG. 1B, and identical numerical labeling is used. FIG. 1C includes inorganic material 150 in the form of abrasive particles 150′ spread substantially uniformly throughout matrix material 140. As no optional backing is present, exterior attachment surface 112 includes a surface composed of matrix material 140. This embodiment may be exemplified, for example, by a bonded abrasive or molded abrasive article, known in the art. Similar to the discussion of FIG. 1B, dressing process, prior to and/or during use may be used to expose the abrasive particles at working surface 111. Also, during use, wear of the abrasive article may expose new abrasive particles on working surface 111, refreshing the abrading ability of working surface 111. Matrix material 140 may include the same materials described with respect to the make and size coats discussed previously.

FIG. 1D shows yet another embodiment of cut-out 190 of FIG 1A in more detail. The description of the elements in FIG. 1D are identical to the description of the elements of FIG. 1B and identical numerical labeling is used. FIG. 1D includes abrasive member 110 with inorganic material 150 in the form of abrasive particles 150′ in a monolayer at working surface 111. The abrasive particles 150′ are partially embedded in matrix material 140 with abrasive particles 150′ protruding from matrix material 140 at working surface 111. This embodiment is exemplified, for example, by a sintered abrasive, known in the art. In some embodiments, diamond abrasive particles are preferred. Matrix material 140 may include any of the previously discussed matrix materials. Matrix material 140 may also include metals, metal alloys or metal mixtures, e.g. metal powder mixtures, sinterable or brazing metals, metal alloys or metal mixtures, e.g. sinterable metal powder mixtures. The matrix material used in the abrasive member to affix the abrasive particles 150′ can include a metal, such as, for example, tin, bronze, silver, iron, and alloys, titanium, titanium alloys, zirconium, zirconium alloys, nickel, nickel alloys, chrome, and chrome alloys, stainless steel and combinations thereof. One particularly useful alloy is nickel-chrome alloy. The abrasive particles may have a designed spatial distribution, e.g. a designed pattern or repeating pattern, or may have a random spatial distribution.

FIG. 1E shows a schematic top view of another embodiment of the abrasive article of FIG. 1A. FIG. 1E shows abrasive article 100, including abrasive member 110 with working surface 111, abrasive particles 150′ and matrix 140. The spatial distribution of the abrasive particles, i.e. the arrangement of the abrasive particles, in the working surface may be random.

FIG. 1F shows a schematic top view of yet another embodiment of the abrasive article of FIG. 1A. FIG. 1F shows abrasive article 100, including abrasive member 110 with working surface 111, abrasive particles 150′ and matrix 140. The spatial distribution of the abrasive particles, i.e. the arrangement of the abrasive particles, in the working surface is a specific pattern. Patterns known in the art may be used including, but not limited to a hexagonal lattice, a square lattice, a rectangular lattice, a rhombic lattice, concentric circles, squares, triangles and the like. The pattern may be a repeating pattern.

In some embodiments, the abrasive particle density in working surface 111 may be greater than about 100, greater than about 200, greater than about 400 particles/cm²; less than about 10000, less than about 5000 or even less than about 1000 particles/cm².

In some embodiments, the inorganic material of the abrasive members of the present disclosure may be abrasive particles. The abrasive particles include, but are not limited to, at least one of garnet, zirconia, spinel, zirconium silicate, chromium, silicon nitride, tantalum carbide, aluminum oxide, silicon carbide, tungsten carbide, titanium carbide, boron, boron nitride, boron carbide, rhenium diboride, titanium diboride, diamond, diamond like carbon, ultra-hard fullerite, rhenium diboride, and nanocrystaline diamond including aggregated diamond nanorods. Combinations of two or more abrasive particles may be used. The abrasive particle size is not particularly limited and includes particle sizes generally known in the art.

In one embodiment, the matrix material is one or more metals and the inorganic material is diamond particles.

FIG. 1G shows another embodiment of cut-out 190 of FIG. 1A in more detail. Many of the elements in FIG. 1G are identical to the elements of FIG. 1B and, in these cases, identical numerical labeling is used. Abrasive member 110 of FIG. 1G includes matrix material 140, including a plurality of precisely shaped features 160, and optional, matrix material support 142. Abrasive member 110 includes abrasive particles (not shown) contained in matrix material 140. Working surface 111 includes the distal ends and side surfaces of the plurality of precisely shaped features 160. The precisely shaped features may be fabricated by any known method in the art, including, but not limited to, machining, micro-machining, micro-replication, molding, extruding, injection molding, and the like, such that precisely shaped features are fabricated and are reproducible from part to part and within a part, reflecting the ability to replicate a design. Precisely shaped features, i.e. topographical features, may be prepared by casting or molding matrix material 140 in a production tool, e.g. a mold or embossing tool, wherein the production tool has a plurality of micron size to millimeter size topographical features. Upon removing the matrix material from the production tool, a series of micron sized to millimeter size topographical features are present in the surface of the matrix material. The topographical features of the matrix material have the inverse shape as the features of the original production tool. This process may be referred to as a micro-replication fabrication technique and yields a micro-replicated abrasive, e.g. a precisely shaped abrasive. Matrix material 140 may be a polymer or polymer precursor that is later cured to form a polymer. Matrix material 140 may include the same materials discussed with respect to the make and size coats described above. In embodiments where a polymer precursor is used to form matrix material 140, polymer precursor systems that cure by a cationic, anionic or free radical cure mechanism are particularly useful. The polymer or polymer precursor that is used to form the precisely shaped features includes an inorganic material (not shown) in the form of abrasive particles, yielding abrasive member 110. The abrasive particles may be those previously described. Matrix material 140 may be fabricated on an optional matrix material support 142. Optional matrix material support 142 may be any of the previously described backings. Matrix material support 142 may be non-ferromagnetic. In some embodiments, the matrix material support would include exterior attachment surface 112.

In another embodiment similar to the previous embodiment, matrix material 140 includes precisely shaped features 160 which are integrally formed with matrix material support 142, FIG. 1H. Matrix material 140 and matrix material support 142 may then be the same material and may be designated as a single layer. Abrasive member 110 includes abrasive particles (not shown) contained in matrix material 140. Working surface 111 includes the distal ends and side surfaces of the plurality of precisely shaped features 160.

FIG. 1I shows another embodiment of cut-out 190 of FIG 1A in more detail. Many of the elements in FIG. 1I are identical to the elements of FIG. 1B and, in these cases, identical numerical labeling is used. Abrasive member 110 includes matrix material 140 and an inorganic material 150 in the form of an inorganic coating 150″. Inorganic coating 150″ may be formed by any known techniques in the art, including, but not limited to, chemical vapor deposition (CVD) and physical vapor deposition (PVD). Matrix material 140 may be polymeric, metal or ceramic. The matrix material may include previously discussed polymeric materials. The matrix material may be a ceramic material. Particularly useful ceramic materials are disclosed in PCT Publ. Appl. Nos. WO2014/022453, WO2014/022462 and WO2014/022465, all of which are incorporated herein by reference in their entirety. Ceramic materials include, but are not limited to carbides, e.g. silicon carbide, boron carbide, zirconium carbide, titanium carbide, tungsten carbide or combinations thereof. In some embodiments, the ceramic is at least about 50 percent, at least about 70 percent, and even at least about 90 percent carbide by weight. In some embodiments, the ceramic is between about 70% and about 99.9% by weight or even between about 90% and about 99.9% by weight.

FIG. 1J shows yet another embodiment of cut-out 190 of FIG 1A in more detail. Many of the elements in FIG. 1J are identical to the elements of FIG. 1I and, in these cases, identical numerical labeling is used. Abrasive member 110 includes matrix material 140 and an inorganic material 150 in the form of an inorganic coating 150″. Inorganic coating 150″ may be formed by any known techniques in the art, including, but not limited to, chemical vapor deposition (CVD) and physical vapor deposition (PVD). The abrasive member 110 further includes a plurality of precisely shaped features 160 fabricated from matrix material 140. Inorganic material 150 in the form of an inorganic coating 150″ coats precisely shaped features 160. Working surface 111 includes the coated surface of the plurality of precisely shaped features 160, including the coated tips. Precisely shaped features 160 can be formed through machining, micromachining, microreplication, molding, extruding, injection molding and ceramic pressing, etc. such that precisely shaped features are fabricated and are reproducible from part to part and within a part, reflecting the ability to replicate a design. Matrix material 140 may be polymeric, metal or ceramic, ceramic being particularly useful. In one embodiment, a ceramic die pressing process is used to form the precisely shaped features. The ceramic material may be those previously described. The ceramic material may be a green body ceramic or a sintered ceramic. The green body ceramic is the unsintered, compacted ceramic element, as would be normally referred to by those skilled in the art. A green body ceramic may be sintered to achieve high density, rigidity, fracture toughness and good feature fidelity, forming a sintered ceramic.

The inorganic coating may be formed by any known techniques in the art, including, but not limited to, chemical vapor deposition (CVD) and physical vapor deposition (PVD). Particularly useful ceramic materials and inorganic coatings and methods of making thereof are disclosed in PCT Publ. Appl. Nos. WO2014/022453, WO2014/022462 and WO2014/022465, all of which are incorporated herein by reference in their entirety. In some embodiments, the inorganic coating of the abrasive member include, but is not limited to, at least one of garnet, zirconia, spinel, zirconium silicate, chromium, silicon nitride, tantalum carbide, aluminum oxide, silicon carbide, tungsten carbide, titanium carbide, boron, boron nitride, boron carbide, rhenium diboride, titanium diboride, diamond, diamond like carbon, ultra-hard fullerite, rhenium diboride, and nanocrystaline diamond including aggregated diamond nanorods. Combinations of two or more inorganic coating may be used, in the form of layers or separate discrete regions. In some embodiments, the inorganic material comprises an inorganic coating disposed on at least a portion of the matrix material that is proximate to the working surface. The inorganic coating may be an abrasion resistant coating.

In one embodiment, the matrix material is a ceramic material, e.g. green body ceramic or sintered ceramic, and the inorganic coating is selected from at least one of diamond and diamond like carbon.

In some embodiments, at least one of the inorganic material, the matrix material and the backing are selected such that the at least one of the abrasive material, matrix material and backing does not allow coupling of the abrasive member to the magnetic member by magnetic force. In some embodiments, the amount of at least one of the inorganic material, the matrix material and the backing are selected such that the at least one of the abrasive material, matrix material and backing does not allow coupling of the abrasive member to the magnetic member by magnetic force.

The abrasive articles of the present disclosure include abrasive member 110 including working surface 111, exterior attachment surface 112 with inorganic material 150. Exterior attachment surface 112 is not designed to be a working surface and may exhibit significantly less abrading ability than working surface 111, as measured, for example, by a conventional abrading removal rate test. In some embodiments, a ratio of a removal rate obtained from the exterior attachment surface relative to a removal rate obtained from the working surface is less than about 0.5, less than about, 0.3, less than about 0.1, less than about, 0.05, or even less than about 0.02, when the removal rates are measured under the same test conditions using the same substrate being abraded. Although a specific test is not defined, one of ordinary skill in the art can select a test method and corresponding test conditions, based on the structure of the abrasive article and the substrate being abraded, and conduct the test on the abrasive member's working surface and exterior attachment surface and determine the removal rate ratio.

In another embodiment of the present disclosure, an abrasive article comprises an abrasive member according to any of the previously disclosed abrasive members, the abrasive member having a working surface and an exterior attachment surface disposed opposite the working surface, wherein the abrasive member comprises a matrix material and an inorganic material having a Mohs hardness greater than about 7.0; a magnetic member having opposing first and second major surfaces, wherein the first major surface of the magnetic member faces the exterior attachment surface; and an adhesive member interposed between and in contact with the exterior attachment surface and first major surface of the magnetic member. The adhesive member adheres the abrasive member to the magnetic member. In some embodiments, the adhesive member adheres the exterior attachment surface of the abrasive member to the first major surface of the magnetic member. In some embodiments, the region between the working surface of the abrasive member and first major surface of the magnetic member is free of a coupling structure that couples the abrasive member to the magnetic member by magnetic force. In some embodiments, the magnetic member is coupled to abrasive member by a non-magnetic force. The magnetic member may be permanently affixed to the abrasive member. The abrasive article may include a third member. In some embodiments, the third member does not include a shaft, e.g. a drive shaft, suitable for driving or rotating the abrasive article during use.

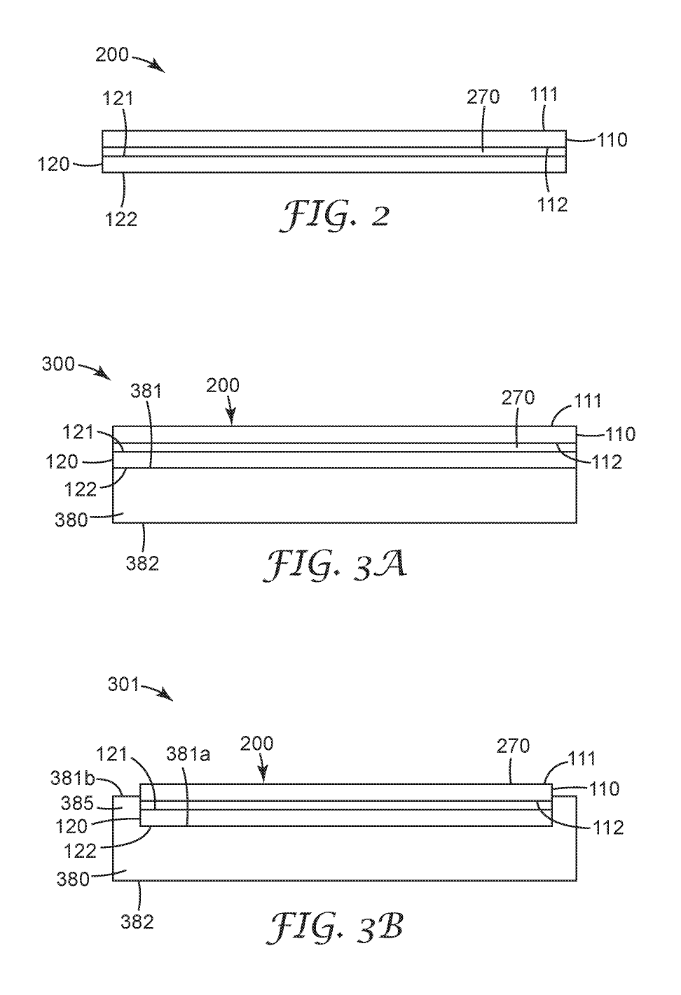

FIG. 2 shows abrasive article 200 including abrasive member 110 having opposing major surfaces, which include working surface 111 and exterior attachment surface 112, and a magnetic member 120, having opposing first major surface 121 and second major surface 122, wherein first major surface 121of magnetic member 120 faces exterior attachment surface 112. Abrasive member 110 may be any of the previously described abrasive members. Adhesive member 270 is interposed between and in contact with exterior attachment surface 112 of abrasive member 110 and first major surface 121 of magnetic member 120. Adhesive member 270 may be a single adhesive layer or may comprise two or more adhesive layers (not shown). Adhesive member 270 may include other layers, such as backings, supports and the like (not shown). For example, adhesive member 270 may include a polymeric backing having two, opposing major surfaces, with each major surface having an adhesive disposed thereon, e.g. double coated tape. The adhesive or adhesives used to form adhesive member 270 are not particularly limited. Adhesive member 270 may include, but is not limited to, at least one of a pressure sensitive adhesive, a thermosetting adhesive and a heat activatable adhesive, e.g. a hot melt adhesive. If the adhesive member comprises multiple adhesive layers, the adhesive layers may be the same adhesive or different adhesives. Useful adhesives include, but are not limited to, epoxies, polyesters, polyurethanes, resorcinols, polyimides, silicones and acrylates. In some embodiments, a thermosetting adhesive, e.g. a thermosetting epoxy, may find particular utility. In some embodiments, a pressure sensitive adhesive, e.g. an acrylic pressure sensitive adhesive, may find particular utility. In some embodiments, the adhesive member is non-ferromagnetic. In some embodiments, the adhesive member is selected such that the adhesive member does not allow coupling of the abrasive member to the magnetic member by magnetic force.

The adhesive member may include one or more adhesion promoters that improve bonding to one or both of the exterior attachment surface of the abrasive member and the first major surface of the magnetic member. Additionally, one or both of the exterior attachment surface of the abrasive member and the first major surface of the magnetic member may include an adhesion promoter thereon, e.g. a primer, which facilitates bonding to the adhesive member. The adhesive member may be adhered to the exterior attachment surface of the abrasive member and the first major surface of the magnetic member by conventional techniques known in the art, including but not limited to, lamination of a pressure sensitive adhesive transfer tape or double sided pressure sensitive adhesive tape, die coating of a hot melt adhesive, melt press bonding of a hot melt adhesive film, coating of a liquid “cure in place” adhesive followed by curing. In some embodiments, the adhesive member is substantially planar.

The abrasive articles of the present disclosure may include a third member. In some embodiments of the abrasive articles of the present disclosure, the magnetic member is the primary means within the abrasive article for attaching the abrasive article to the third member. In other embodiments, the magnetic member is the only means within the abrasive article for attaching the abrasive article to a third member.

In another embodiment of the present disclosure, an abrasive article comprises an abrasive article according to any of the previously disclosed abrasive articles, the abrasive article further comprises a third member having a first major surface and a second major surface, wherein the first major surface of the third member faces the second major surface of the magnetic member and wherein the third member comprises a ferromagnetic material and is attached to the magnetic member by a magnetic force. In some embodiments, the magnetic force (of attachment) is greater than a corresponding force acting on the magnetic member and the abrasive member due to the acceleration due to gravity. In some embodiments, the magnetic force (of attachment) is greater than two times a corresponding force acting on the magnetic member and the abrasive member due to the acceleration due to gravity. When defining the mass of the abrasive member and the magnetic member on which the acceleration due to gravity is acting upon, included in the mass is any material located between the abrasive member and magnetic member, e.g. an adhesive member. In some embodiments, the third member is not a permanent magnet and/or the third member is free of one or more fabricated permanent magnets contained fully or partially within cavities located in the third member.

FIG. 3A shows abrasive article 300, including abrasive article 200, as previously described. Abrasive article 300 further includes third member 380 having first major surface 381 and second major surface 382. Third member 380 comprises a ferromagnetic material and is attached to the magnetic member 120 by a magnetic force. In some embodiments, the third member 380 consists essentially of a ferromagnetic material, e.g. a ferromagnetic plate. In other embodiments, the third member may be a composite or a laminate construction. The third member may comprise a polymeric material and a ferromagnetic material selected from at least one of a plurality of ferromagnetic particles, at least one ferromagnetic plate and combinations thereof. Optionally, the ferromagnetic material may be at least partially contained within the polymeric material. The ferromagnetic material may include, but is not limited to, at least one of iron, nickel, cobalt and gadolinium. Particularly useful ferromagnetic materials include at least one of ferromagnetic steel and ferromagnetic stainless steel. In some embodiments the third member comprises ferromagnetic stainless steel. Although the abrasive article of FIG. 3A shows abrasive article 200 to be of the same width of third member 380, in some embodiments, abrasive member 200 may have a smaller width than third member 380 or a larger width than abrasive third member 380. Note, in FIG. 3A, the width of the abrasive article runs parallel to working surface 111. The third member may optionally include a raised rim.

In some embodiments, the third member may include a raised rim, creating a recess. The recess is configured to receive an abrasive article, for example abrasive article 200, which includes at least an abrasive member and a magnetic member. FIG. 3B shows abrasive article 301, including abrasive article 200, as previously described. Abrasive article 300 further includes third member 380 having first major surfaces 381a and 381b and second major surface 382 and raised rim 385. Raised rim 385 is configured to receive abrasive article 200, such that, working surface 111 of abrasive member 110 is above first major surface 381b, allowing working surface 111 to make contact with the substrate to be abraded. The outer edges of the raised rim may be beveled.

Other materials, e.g. a thin film used for dampening or improved planarity of the abrasive article, may be disposed between the third layer and the magnetic member, provided the added material does not interfere with the ability of the third member to be attached to the magnetic member by magnetic force.

In some embodiments, abrasive article 200 may have a smaller width than third member 380, abrasive article 200 may then be referred to as an abrasive segment. In these embodiments, the first major surface of the third member faces the second major surface of the magnetic member of each abrasive segment, the third member comprises a ferromagnetic material and the abrasive segments are attached to the third member by a magnetic force.

The number of abrasive segments attached to a third member by a magnetic force is not particularly limited. In some embodiments, at least 1, at least 2, at least 3 at least 4, at least 5, at least 6 or even at least 10 abrasive segments may be attached to third member 380 by a magnetic force. In some embodiments, up to 20, up to 30, up to 40 and even up to 100 abrasive segments may be attached to the third member by a magnetic force. In some embodiments, between 1 and 100, between 1 and 40, between 1 and 30, between 1 and 20, between 1 and 10, between 2 and 100, between 2 and 40, between 2 and 20 or even between 2 and 10 abrasive segments may be attached to the third member by a magnetic force.

In the abrasive article of the present disclosure, the magnetic member may be any magnetic member known in the art. The magnetic member may be a composite material, fabricated from a polymer matrix which includes a magnetic material, e.g. a ferromagnetic, material dispersed in the polymer matrix. The ferromagnetic material may be a ferromagnetic powder. The polymer matrix may be stiff, e.g. thermoset or thermoplastic material having a glass transition temperature at least above about room temperature, typically at least about 20 degrees centigrade, at least about 40 degrees centigrade, at least about 100 degrees centigrade or even at least about 150 degrees centigrade above room temperature and no greater than about 350 degrees centigrade above room temperature. The polymer matrix may be flexible, e.g. a thermoset or thermoplastic having a glass transition temperature at least below about room temperature, typically at least about 10 degrees centigrade, at least about 20 degrees centigrade, at least about 40 degrees centigrade or even at least about 100 degrees centigrade below room temperature and no less than about 170 degrees centigrade below room temperature. Use of a stiff polymer matrix results in a stiff magnetic member. Use of a flexible polymer matrix results in a flexible magnetic member. In some embodiments, the magnetic member may have a thickness greater than about 0.1 mm, greater than about 0.2 mm, greater than about 0.5 mm and even greater than about 1 mm; less than about 10 mm, less than about 5 mm, less than about 4 mm, less than about 3 mm or even less than about 2 mm. In some embodiments, the magnetic member may be between about 0.1 mm and 10 mm, between about 0.1 mm and about 5 mm, between about 0.1 mm and about 3 mm or even between about 0.5 mm and about 3 mm. In some embodiments, the magnetic member may be a magnetic sheet, such as Flexible Rubber Magnet, product number NP12, available from, Nihon Industrial Products Pte Ltd, Midview City, Singapore. In some embodiments, the magnetic member is substantially planar.

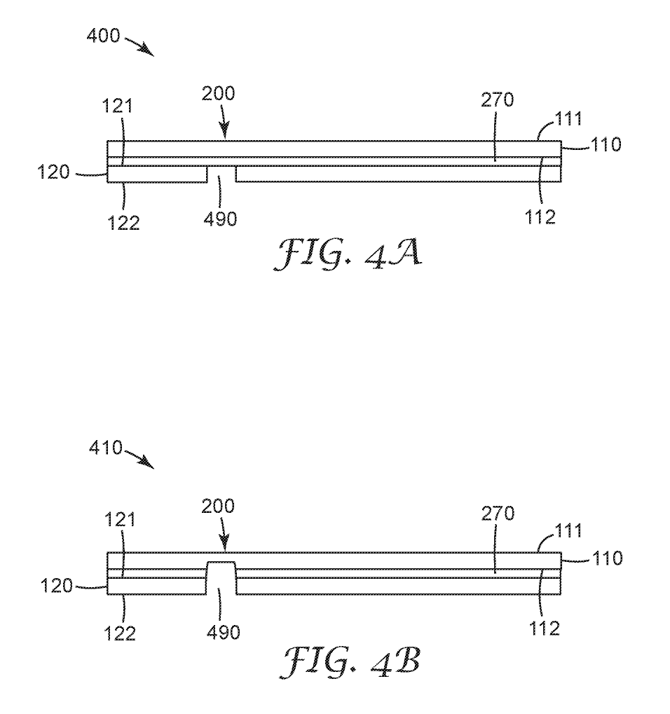

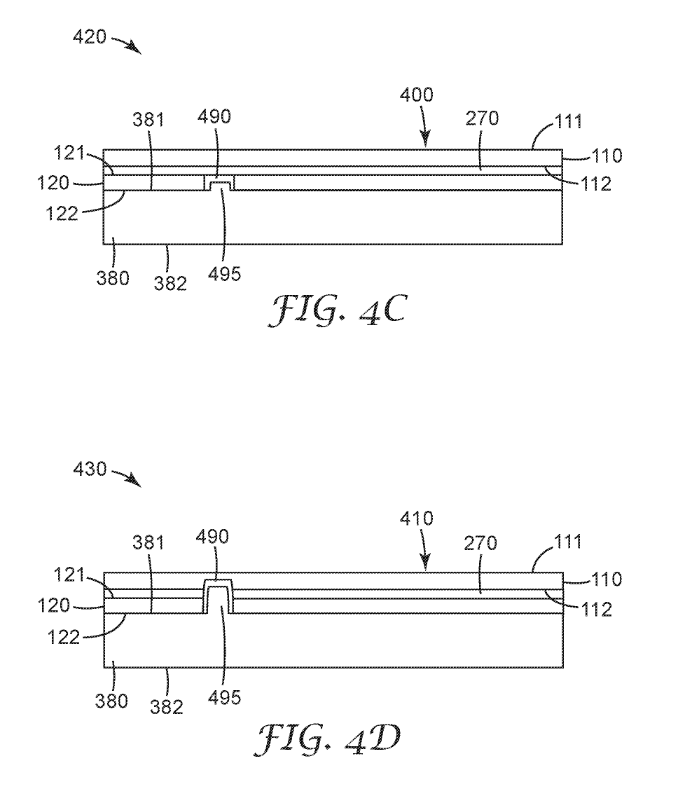

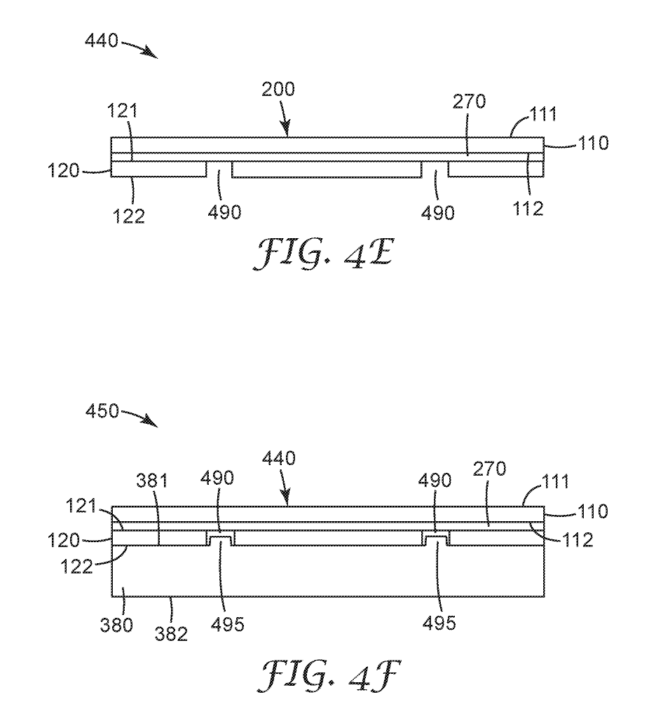

In another embodiment of the present disclosure, an abrasive article comprises an abrasive article according to any of the previously disclosed abrasive articles, wherein the magnetic member includes at least one alignment cavity extending into the magnetic member. FIG. 4A shows abrasive article 400, including abrasive article 200, as previously described. Abrasive article 400 further includes alignment cavity 490 extending into magnetic member 120. Although alignment cavity 490 extends to adhesive member 270, it may only extend partially into magnetic member 120 or may extend into adhesive member 270. In some embodiments, the alignment cavity may extend into the abrasive member. FIG. 4B depicts abrasive article 410 having alignment cavity 490 extending through both magnetic member 120, adhesive member 270 and into abrasive member 110.

In yet another embodiment, the abrasive article may include a third member that includes at least one alignment pin. The alignment pin is designed, i.e. sized and located, to match the alignment cavity of the abrasive article. This enables the abrasive member with attached magnetic member to be place in the desired spatial position, relative to the third member. FIG. 4C shows abrasive article 420, which includes abrasive article 400, as previously described, and further includes third member 380 with alignment pin 495. Alignment pin 495 is positioned in alignment cavity 490, to facilitate aligning abrasive article 400 with third member 380. Similarly, FIG. 4D shows abrasive article 430, which includes abrasive article 410, as previously described, and further includes third member 380 with alignment pin 495. Alignment pin 495 is positioned in alignment cavity 490, to facilitate aligning abrasive article 410 with third member 380. The alignment pin may be integrally formed, for example through machining, with third member 380 or may be a separate component.

In another embodiment an abrasive article comprises an abrasive article according to any of the previously disclosed abrasive articles, wherein the magnetic member includes at least two alignment cavities extending into the magnetic member. FIG. 4E shows abrasive article 440, including abrasive article 200, as previously described. Abrasive article 440 further includes alignment cavities 490 extending into magnetic member 120. Although alignment cavity 490 extends to adhesive member 270 in FIG. 4E, it may only extend partially into magnetic member 120, may extend into adhesive member 270 or may extend into abrasive member 110. In yet another embodiment, the previous abrasive article may further include a third member having at least two alignment pins. FIG. 4F shows abrasive article 450, which includes abrasive article 440, as previously described, and further includes third member 380 with alignment pins 495. Each of the alignment pins 495 are positioned in one of the alignment cavities 490, to facilitate aligning abrasive article 440 with third member 380. The alignment pin or pins may be integrally formed, for example through machining, with third member 380 or may be a separate component.

In FIGS. 4E and 4F, the alignment pins are shown to be the same length and the alignment cavities are shown to be the same depth. However, the length of the alignment pins may vary, so long as the depth of the corresponding alignment cavities is adjusted to accommodate the alignment pin length. The alignment pins and cavities should be designed to allow first major surface 381 of third member 380 to come into close proximity and/or contact second major surface 122 of magnetic member 120, i.e. to allow third member 380 to be attached to magnetic member 120 by a magnetic force. In FIGS. 4E and 4F, the alignment pins are shown to be the same width and the alignment cavities are shown to be the same width. However, the width of the alignment pins may vary, so long as the width of the corresponding alignment cavities is adjusted to accommodate the alignment pin width, according to the described tolerances herein.

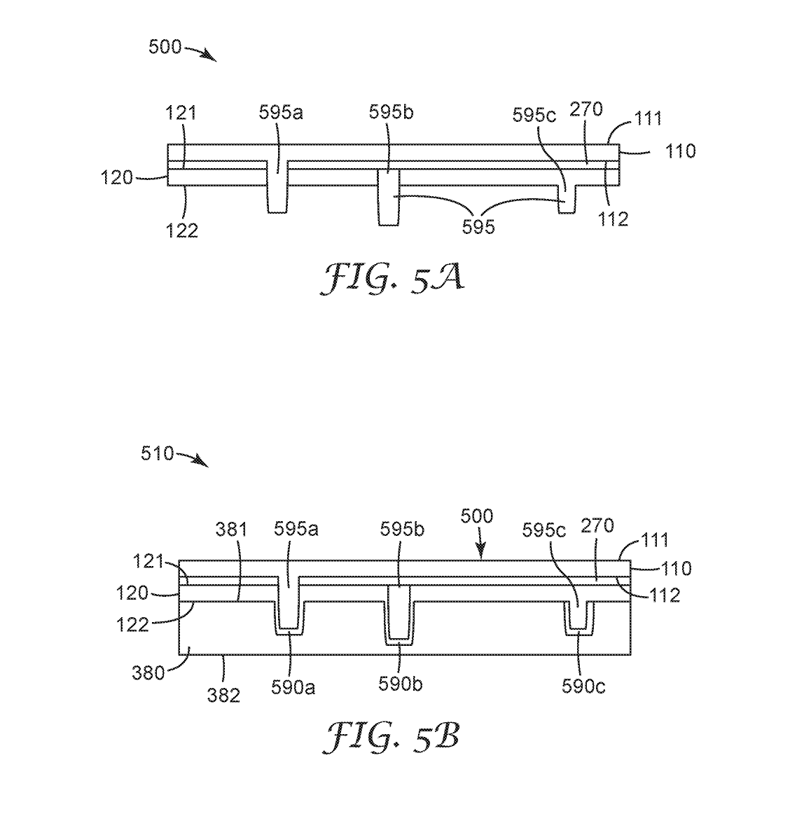

In another embodiment of the present disclosure, an abrasive article comprises an abrasive member according to any of the previously disclosed abrasive members wherein the abrasive member includes at least one alignment pin extending from the plane of the second major surface of the magnetic member. FIG. 5A shows abrasive article 500 including abrasive member 110 having opposing major surfaces which include working surface 111 and exterior attachment surface 112, and a magnetic member 120, having opposing first major surface 121 and second major surfaces 122, wherein first major surface 121of magnetic member 120 faces exterior attachment surface 112. Abrasive article 500 further includes alignment pins 595, further defined as alignment pins 595a, 595b and 595c, extending from the plane of second major surface 122 of magnetic member 120. Alignment pin 595a begins from attachment surface 112 of abrasive member 110 and extends from the plane of second major surface 122 of magnetic member 120. Alignment pin 595b begins at the surface of adhesive member 270 and extends from the plane of second major surface 122 of magnetic member 120. Alignment pin 595c begins second major surface 122 of magnetic member 120 and extends from the plane of second major surface 122 of magnetic member 120. Although three different alignment pins are shown, the alignment pins may all be the same, i.e. they may have the same length, width and starting depth with respect to the thickness of the abrasive article, or they may be different. In yet another embodiment, the previous abrasive article may include a third member that includes at least one alignment cavity. The at least one alignment cavity is designed, i.e. sized and located, to match the at least one alignment pin of the abrasive article. This enables the abrasive member with attached magnetic member to be place in the desired spatial position, relative to the third member. FIG. 5B shows abrasive article 510, which includes abrasive article 500, as previously described, and further includes third member 380 with alignment cavities 590a, 590b and 590c. Each of the alignment pins 595a, 595b and 595c are positioned in one of the alignment cavities 590a, 590b and 590c, to facilitate aligning abrasive article 500 with third member 380.

The number of alignment pins and alignment cavities is not particularly limited and may include 1, 2, 3, 4, 5 or even more. In some embodiments, the number of alignment pins and alignment cavities is between about 1 and about 40, about 1 and about 30, between about 1 and about 20, between about 1 and about 10 or even between about 2 and about 10. The number of alignment pins may be the same or less than the number of alignment cavities. In some embodiments, the number of alignment pins is the same as the number of alignment cavities. If more than one alignment cavity and alignment pin are used, the alignment pins are designed, i.e. sized and located, to match the alignment cavities of the abrasive article. Generally, the alignment pin is sized to be slightly smaller in width and height than the width and depth of the alignment cavity, so that the pin can slide smoothly into the cavity. The alignment pins and cavities are not designed to attach a third member to an abrasive article, a magnetic member and/or an abrasive member. The tolerance between an alignment pin wall and a cavity wall may be greater than about 0.01 mm, greater than about 0.05 mm, or even greater than about 0.1 mm; less than about 2.0 mm, less than about 1.0 mm, less than about 0.5 mm, less than about 0.3 mm, less than about 0.2 mm or even less than about 0.18 mm. The length of the alignment pin is selected such that it is shorter than the depth of the alignment cavity, enabling first major surface 381 of third member 380 to come into close proximity and/or contact with second major surface 122 of magnetic member 120. In some embodiments, the length of the alignment pins is at least about 10 microns less than, at least about 25 microns less than, at least about 50 microns less than, at least about 100 microns less than, at least about 250 microns less than, at least about 500 microns less than, at least about 1 mm less than, at least about 2 mm less than, or even at least about 5 mm less than the depth of the alignment cavity. In some embodiments, the length of the alignment pins is no greater than about 10 mm less than the depth of the alignment cavity. In embodiments that include more than one alignment pin and more than one alignment cavity, the alignment pins may all be the same height or differing heights and the pins may be of the same widths or differing widths, so long as the depth and width of the corresponding alignment cavities are adjusted to accommodate the alignment pin height and width, allowing the first major surface of the third member to come into close proximity and/or contact with the second major surface of the magnetic member, i.e. to allow the third member to be attached to the magnetic member by a magnetic force.

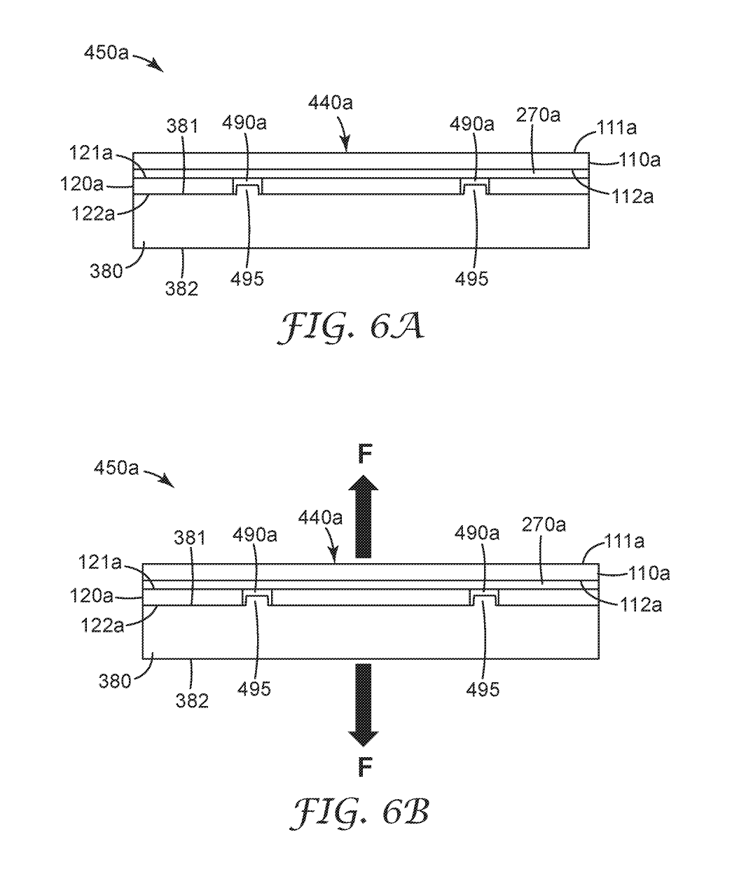

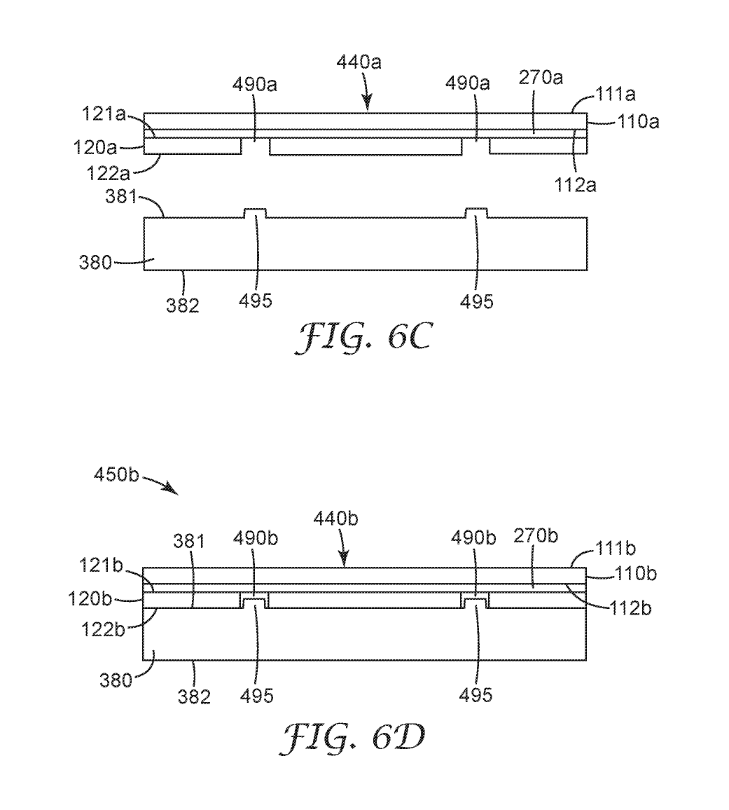

In other embodiments the present disclosure provides a method of separating an abrasive member from an abrasive article and a method of replacing an abrasive member of an abrasive article. The method of separating an abrasive member from an abrasive article includes providing an abrasive article having an abrasive member, magnetic member and third member according to any of the preceding embodiments, applying a separating force to at least one of the abrasive member, the magnetic member and the third member, wherein the separating force exceeds the magnetic force between the magnetic member and third member causing the abrasive member and attached magnetic member to separate from the third member. FIGS. 6A-6C shows an example of a method of separating an abrasive member from an abrasive article. The method of separating an abrasive member from an abrasive article includes providing an abrasive article 450a, as previously described (abrasive article 450 of FIG. 4F), which includes abrasive article 440a, as previously described (abrasive article 440 of FIG. 4E), including abrasive member 110a, having working surface 111a and attachment surface 112a, and a magnetic member 120a having first major surface 121a and second major surface 122a, adhesive member 270a and third member 380 having first major surface 381 and second major surface 382 (FIG. 6A); applying at least one separating force, F, to at least one of the abrasive member 110a, magnetic member 120a and third member 380 (FIG. 6B); wherein the separating force, F, exceeds the magnetic force between the magnetic member 120a and third member 380 causing the abrasive member 110a and attached magnetic member 120a to separate from the third member 380 (FIG. 6C), i.e. abrasive article 440a separates from third member 380.

The method of replacing the abrasive member of an abrasive article includes the previous described method for separating an abrasive member from an abrasive article and further includes: providing a second abrasive article having an abrasive member and a magnetic member, positioning the second abrasive article such that the second major surface of the magnetic member of the second abrasive article is proximate to and faces the first major surface of the third member, and attaching the second major surface of the magnetic member of the second abrasive article to the first major surface of the third member by a magnetic force.

FIGS. 6A-6D shows a method of replacing an abrasive member of an abrasive article. FIGS. 6A-6C are as previously described. FIG. 6D includes providing a second abrasive article 440b, as previously described (abrasive article 440 of FIG. 4E), including abrasive member 110b, having working surface 111b and attachment surface 112b, and a magnetic member 120b having first major surface 121b and second major surface 122b and adhesive member 270b; positioning the second abrasive article 440b such that the second major surface 122b of magnetic member 120b of second abrasive article 440b is proximate to and faces the first major surface 381 of the third member 380, and attaching the second major surface 122b of the magnetic member 120b of the second abrasive article 440b to the first major surface 381 of third member 380 by a magnetic force. The result of this method is that the first or original abrasive member 110a of abrasive article 440a has been replaced by second abrasive member 110b of abrasive article 440b. If the working surface 111a of abrasive member 110a requires replacement, for example if it is worn or dulled due to use, a new abrasive member 110b having a new working surface 111b can easily replace it, via the described method, forming abrasive article 450b. Third member 380 is reused in the formation of abrasive article 450b.

In some embodiments, the abrasive articles of the present disclosure may further include a release mechanism. The release mechanism is configured to facilitate removing the abrasive member and attached magnetic member from the third member. In some embodiments, the release mechanism, includes, but is not limited to, one or more of at least one release tab, at least one release cavity and at least one release edge grove in at least one of the magnetic member, abrasive member and third member. A release mechanism that includes a release cavity may include a corresponding release pin. A release mechanism that includes a release edge grove may include a corresponding release lever. Combinations of release mechanisms may be used. In some embodiments, the third member includes the release mechanism. In some embodiments, the abrasive member includes the release mechanism. In some embodiments, the magnetic member includes the release mechanism.

In one exemplary embodiment, as shown in FIG. 7, abrasive article 700 includes abrasive article 300, as previously described, and further includes release cavity 705. Release cavity 705 is designed such that a release pin 707 can be inserted in release cavity 705. A force, F, may then be applied to release pin 707 and subsequently to second major surface 122 of magnetic member 120. The force, F, enables the separation of magnetic member 120, with attached abrasive member 110, from third member 380. The number of release cavities is not particularly limited. In some embodiments, the number of release cavities may be from between 1 and 10, from between 1 and 6 or even between 1 and 4. The release pin may be integral to abrasive article 700 and be contained in release cavity 705. It may be integrated with a locking and spring mechanism (not shown), for example.

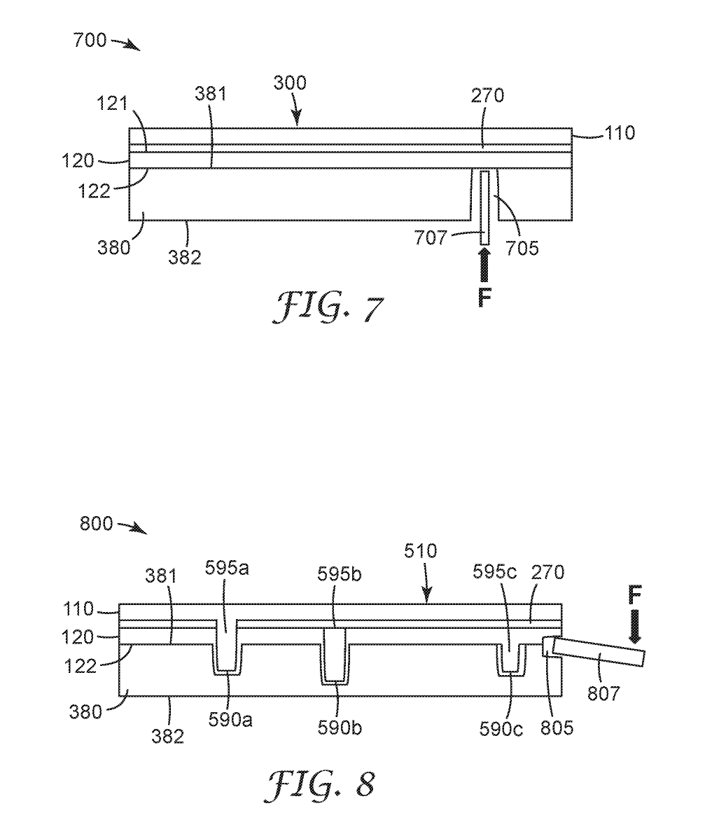

In another exemplary embodiment, as shown in FIG. 8, abrasive article 800 includes abrasive article 510, as previously described, and further includes release edge grove 805. Release lever 807 may be inserted in release edge groove 805. By applying a force, F to release lever 807, a force may be applied to one or both of third member 380 and magnetic member 120, having attached abrasive member 110. The force, F, enables the separation of magnetic member 120, with attached abrasive member 110, from third member 380. In FIG. 8, the release edge groove is shown to be in both the magnetic member and third member. In some embodiments, the edge grove is in at least one of the magnetic member and third member. The number of release edge groves is not particularly limited. In some embodiments, the number of release edge groove may be from between 1 and 10, from between 1 and 6 or even between 1 and 4. The release lever may be integral to abrasive article 800 and be contained in a cavity (not shown) formed in third member 380.

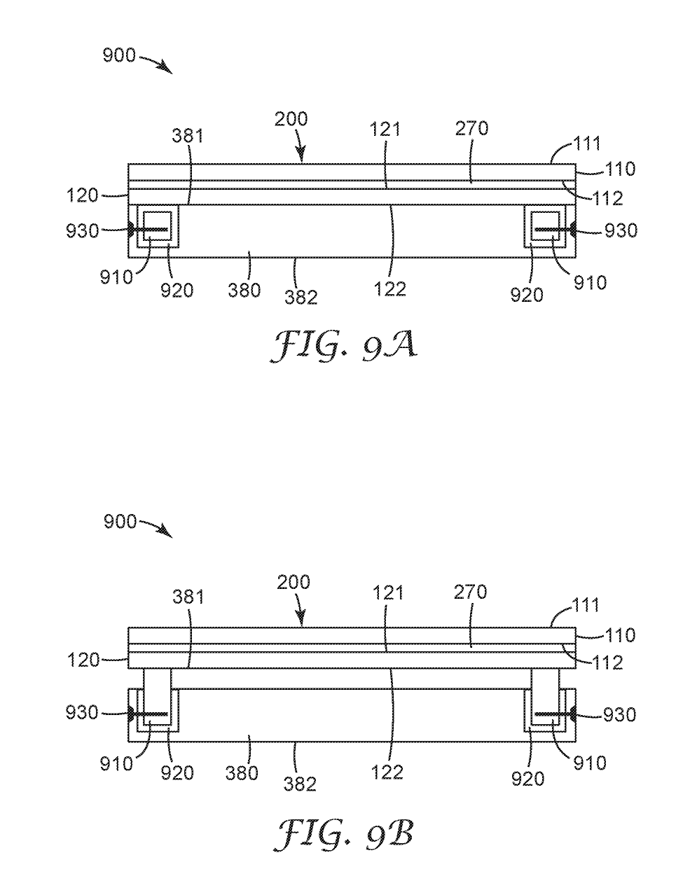

In another exemplary embodiment, as shown in FIG. 9, abrasive article 900 includes abrasive article 200, as previously described, and third member 380 with first and second major surfaces 381 and 382, respectively. Third member 380 has a release mechanism, including release tabs 910 and corresponding screws 930. Release tabs 910 are contained in release cavities 920, which may, for example, be machined or integrally molded in third member 380. In the non-release position, as shown in FIG. 9A, release tabs 910 reside below the plane of second major surface 122 of magnetic member 120. In this configuration, abrasive article 910 may be used in a corresponding abrading application, for example, conditioning, i.e. abrading, a chemical mechanical planarization polishing pad. At the appropriate time, e.g. when working surface 111 if abrasive member 110 is worn or dulled, abrasive article 200, which includes abrasive member 110 and magnetic member 120, can be released from third member 380 by rotating screws 930 which urges tabs 910 against second major surface 122 of magnetic member 120, thereby creating a separating force on second major surface 122 of magnetic member 120. When the separating force created by the rotation of tabs 910 exceeds the magnetic force between the magnetic member 120 and third member 380, abrasive article 200, which includes abrasive member 110 and attached magnetic member 120, separates from the third member 380, FIG. 3B. Once abrasive article 200 is removed from third member 380, screws 930 can be returned to their original positions, causing tabs 910 to rotate back into release cavities 920. A new abrasive article can then be attached by a magnetic force to third member 380. The number of release tabs and corresponding release cavities is not particularly limited. In some embodiment, the number of release tabs may include 1, 2, 3, 4, or even 5 release tabs. In some embodiments, the number of release tabs may be between 1 and 10.

FIGS. 7, 8 and 9 are not limiting and other modifications to provide a force to facilitate separation between third member 380 and magnetic member 120 and/or abrasive member 110 will be known to those of skill in the art.

The abrasive articles are particularly suited for recovering and reusing a third member that has high intrinsic value. For example, the abrasive articles of the present disclosure may be pad conditioners used in chemical mechanical planarization processes. The pad conditioners include a third member that may be a stainless steel plate that provides support for the abrasive member. The third member may be designed to specific tight tolerances and may include a first major surfaces having a planar surface, enabling an abrasive member to be attached thereto, via a magnetic member, and enable the abrasive member to have a corresponding planarity, i.e. planar surface or flatness. In so doing, a correspondingly planar magnetic member and adhesive member may be required. When the abrasive member is worn and no longer useable, the abrasive member and attached magnetic member may be easily replaced by a new abrasive member with attached magnetic member, using the previously disclosed method of separating an abrasive member from an abrasive article and method of replacing an abrasive member of an abrasive article.

Select embodiments of the present disclosure include, but are not limited to, the following:

In a first embodiment, the present disclosure provides an abrasive article comprising:
an abrasive member having a working surface and an exterior attachment surface disposed opposite the working surface, wherein the abrasive member comprises a matrix material and an inorganic material having a Mohs hardness greater than about 7.0; and a magnetic member having opposing first and second major surfaces;
wherein the first major surface of the magnetic member faces the exterior attachment surface.

In a second embodiment, the present disclosure provides an abrasive article according to the first embodiment, wherein the abrasive member comprises an inorganic material having a Mohs hardness greater than about 7.5.

In a third embodiment, the present disclosure provides an abrasive article according to the first or second embodiments, wherein the abrasive member comprises an inorganic material having a Mohs hardness greater than about 8.0.

In a fourth embodiment, the present disclosure provides an abrasive article according to any one of the first through third embodiments, wherein the abrasive member comprises an inorganic material having a Mohs hardness greater than about 9.0.

In a fifth embodiment, the present disclosure provides an abrasive article according to any one of the first through fourth embodiments, wherein the inorganic material comprises abrasive particles that are at least partially contained in a portion of the matrix material that is proximate the working surface.

In a sixth embodiment, the present disclosure provides an abrasive article according to any one of the first through fourth embodiments, wherein the inorganic material comprises an inorganic coating disposed on at least a portion of the matrix material that is proximate to the working surface.

In a seventh embodiment, the present disclosure provides an abrasive article according to any one of the first through sixth embodiments, wherein the inorganic material include at least one of garnet, zirconia, spinel, zirconium silicate, chromium, silicon nitride, tantalum carbide, aluminum oxide, silicon carbide, tungsten carbide, titanium carbide, boron, boron nitride, boron carbide, rhenium diboride, titanium diboride, diamond, diamond like carbon, ultra-hard fullerite, rhenium diboride, and nanocrystaline diamond including aggregated diamond nanorods.

In an eighth embodiment, the present disclosure provides an abrasive article according to any one of the first through sixth embodiments, wherein the inorganic material include at least one of aluminum oxide, silicon carbide, tungsten carbide, titanium carbide, boron, boron nitride, rhenium diboride, titanium diboride, diamond, diamond like carbon, ultra-hard fullerite, rhenium diboride, and nanocrystaline diamond including aggregated diamond nanorods.

In a ninth embodiment, the present disclosure provides an abrasive article according to any one of the first through sixth embodiments, wherein the inorganic material includes at least one of diamond, diamond like carbon, ultra-hard fullerite, rhenium diboride, and nanocrystaline diamond including aggregated diamond nanorods.

In a tenth embodiment, the present disclosure provides an abrasive article according to any one of the first through ninth embodiments, wherein the matrix material comprises a metal.

In an eleventh embodiment, the present disclosure provides an abrasive article according to any one of the first through ninth embodiments, wherein the matrix material comprises a polymer.

In a twelfth embodiment, the present disclosure provides an abrasive article according to any one of the first through ninth embodiments, wherein the matrix material comprises a ceramic.

In a thirteenth embodiment, the present disclosure provides an abrasive article according to any one of the first through ninth embodiments, wherein the matrix material comprises at least one of a green body ceramic and sintered ceramic.

In a fourteenth embodiment, the present disclosure provides an abrasive article according to any one of the first through thirteenth embodiments, wherein the working surface comprises a plurality of precisely shaped features.

In a fifteenth embodiment, the present disclosure provides an abrasive article according to any one of the first through fourteenth embodiments, further comprising an adhesive member interposed between and in contact with the exterior attachment surface of the abrasive member and the first major surface of the magnetic member, wherein the adhesive member couples the abrasive member to the magnetic member.

In a sixteenth embodiment, the present disclosure provides an abrasive article according to the fifteenth embodiment, wherein the adhesive member comprises at least one of a pressure sensitive adhesive, a thermosetting adhesive and a heat activatable adhesive

In a seventeenth embodiment, the present disclosure provides an abrasive article according to the sixteenth embodiment, wherein the adhesive member comprises a pressure sensitive adhesive.

In an eighteenth embodiment, the present disclosure provides an abrasive article according to any one of the first through seventeenth embodiments, wherein the magnetic force is the primary means within the abrasive article for attaching the abrasive article to a third member.

In a nineteenth embodiment, the present disclosure provides an abrasive article according to any one of the first through eighteenth embodiments, wherein the magnetic f is the only means within the abrasive article for attaching the abrasive article to a third member.

In a twentieth embodiment, the present disclosure provides an abrasive article according to any one of the first through nineteenth embodiments, wherein the magnetic member includes at least one alignment cavity extending into the magnetic member.

In a twenty-first embodiment, the present disclosure provides an abrasive article according to any one of the first through nineteenth embodiments, wherein the magnetic member includes at least two alignment cavities extending into the magnetic member.

In a twenty-second embodiment, the present disclosure provides an abrasive article according to any one of the first through nineteenth embodiments, further comprising at least one alignment pin, wherein the at least one alignment pin extends from the plane of the second major surface of the magnetic member.

In a twenty-third embodiment, the present disclosure provides an abrasive article according to any one of the first through nineteenth embodiments, further comprising at least two alignment pins, wherein the at least two alignment pins extend from the plane of the second major surface of the magnetic member.

In a twenty-fourth embodiment, the present disclosure provides an abrasive article according to any one of the first through nineteenth embodiments, further comprising a third member having a first major surface and a second major surface, wherein the first major surface of the third member faces the second major surface of the magnetic member and wherein the third member comprises a ferromagnetic material and is attached to the magnetic member by a magnetic force.

In a twenty-fifth embodiment, the present disclosure provides an abrasive article according to the twenty-fourth embodiment, wherein the third member consist essentially of a ferromagnetic material.

In a twenty-sixth embodiment, the present disclosure provides an abrasive article according to the twenty-fourth embodiment, wherein the third member comprises a polymeric material and a ferromagnetic material selected from at least one of a plurality of ferromagnetic particles, at least one ferromagnetic plate and combinations thereof, and optionally, wherein the ferromagnetic material is at least partially contained within the polymeric material.

In a twenty-seventh embodiment, the present disclosure provides an abrasive article according to any one of the twenty-fourth through twenty-sixth embodiments, wherein the ferromagnetic material includes at least one of iron, nickel, cobalt and gadolinium.

In a twenty-eighth embodiment, the present disclosure provides an abrasive article according to any one of the twenty-fourth through twenty-seventh embodiments, wherein the ferromagnetic material includes at least one of ferromagnetic steel and ferromagnetic stainless steel

In a twenty-ninth embodiment, the present disclosure provides an abrasive article according to any one of the twenty-fourth through twenty-eighth embodiments, wherein the magnetic member includes at least one alignment cavity extending into the magnetic member.

In a thirtieth embodiment, the present disclosure provides an abrasive article according to the twenty-ninth embodiment, wherein the third member further comprises at least one alignment pin and wherein each of the at least one alignment pin aligns with and extends into one of the at least one alignment cavity.

In a thirty-first embodiment, the present disclosure provides an abrasive article according to any one of the twenty-fourth through twenty-eighth embodiments, wherein the magnetic member includes at least two alignment cavities extending into the magnetic member.

In a thirty-second embodiment, the present disclosure provides an abrasive article according to the thirty-first embodiment, wherein the third member further comprises at least two alignment pins and wherein each of the at least two alignment pins align with and extend into one of the at least two alignment cavities.

In a thirty-third embodiment, the present disclosure provides an abrasive article according to any one of the twenty-fourth through twenty-eighth embodiments, further comprising at least one alignment pin, wherein the at least one alignment pin extends from the plane of the second major surface of the magnetic member.

In a thirty-fourth embodiment, the present disclosure provides an abrasive article according to the thirty-third embodiment, wherein the third member comprises at least one alignment cavity and wherein each of the at least one alignment pin extends into one of the at least one alignment cavity.

In a thirty-fifth embodiment, the present disclosure provides an abrasive article according to any one of the twenty-fourth through twenty-eighth embodiments, further comprising at least two alignment pins, wherein the at least two alignment pins extend from the plane of the second major surface of the magnetic member.

In a thirty-sixth embodiment, the present disclosure provides an abrasive article according to the thirty-fifth embodiment, wherein the third member comprises at least two alignment cavities and wherein each of the at least two alignment pins extend into one of the at least two alignment cavities.

In a thirty-seventh embodiment, the present disclosure provides an abrasive article according to any one of the twenty-fourth through thirty-sixth embodiment embodiments, wherein the abrasive article includes a release mechanism.

In a thirty-eighth embodiment, the present disclosure provides an abrasive article according to the thirty-seventh embodiment, wherein the release mechanism includes one or more of at least one release tab, at least one release cavity and at least one release edge grove.

In a thirty-ninth embodiment, the present disclosure provides an abrasive article according to any one of the twenty-fourth through thirty-eighth embodiments, wherein the region between the working surface of the abrasive member and first major surface of the magnetic member is free of a coupling structure that couples the abrasive member to the magnetic member by magnetic force.

In a fortieth embodiment, the present disclosure provides an abrasive article according to any one of the twenty-fourth through thirty-ninth embodiments, wherein the magnetic member is coupled to abrasive member by a non-magnetic force.

In a forty-first embodiment, the present disclosure provides an abrasive article according to any one of the twenty-fourth through fortieth embodiments, wherein a ratio of a removal rate obtained from the exterior attachment surface relative to a removal rate obtained from the working surface is less than about 0.5, less than about, 0.3, less than about 0.1, less than about, 0.05, or even less than about 0.02, when the removal rates are measured under the same test conditions using the same substrate being abraded

In a forty-second embodiment, the present disclosure provides an abrasive article according to any one of the first through twenty-third embodiment embodiments, wherein the abrasive article includes a release mechanism.

In a forty-third embodiment, the present disclosure provides an abrasive article according to the forty-second embodiment, wherein the release mechanism includes one or more of at least one release tab, at least one release cavity and at least one release edge grove.

In a forty-fourth embodiment, the present disclosure provides an abrasive article according to any one of the first through twenty-third, forty-second and forty-third embodiments, wherein the region of the abrasive article between the working surface of the abrasive member and first major surface of the magnetic member is free of a coupling structure that couples the abrasive member to the magnetic member by a magnetic force.

In a forty-fifth embodiment, the present disclosure provides an abrasive article according to any one of the first through twenty-third, forty-second through forty-forth embodiments, wherein the magnetic member is coupled to abrasive member by a non-magnetic force.

In a forty-sixth embodiment, the present disclosure provides an abrasive article according to any one of the first through twenty-third, forty-second through forty-fifth embodiments, wherein a ratio of a removal rate obtained from the exterior attachment surface relative to a removal rate obtained from the working surface is less than about 0.5, less than about, 0.3, less than about 0.1, less than about, 0.05, or even less than about 0.02, when the removal rates are measured under the same test conditions using the same substrate being abraded.

In a forty-seventh embodiment, the present disclosure provides a method of separating an abrasive member from an abrasive article comprising:

providing an abrasive article according to any one of the twenty-fourth through forty-first embodiments, and

applying a separating force to at least one of the abrasive member, the magnetic member and the third member, wherein the separating force exceeds the magnetic force between the magnetic member and third member causing the abrasive member and attached magnetic member to separate from the third member.

In a forty-seventh embodiment, the present disclosure provides a method of replacing the abrasive member of an abrasive article comprising:

providing an abrasive article according to any one of the twenty-fourth through forty-first embodiments,

applying a separating force to at least one of the abrasive member, the magnetic member and the third member, wherein the separating force exceeds the magnetic force between the magnetic member and third member causing the abrasive member and attached magnetic member to separate from the third member,

providing a second abrasive article according to any one of the first through twenty-third and forty-second through forty-sixth embodiments,

positioning the second abrasive article such that the second major surface of the magnetic member of the second abrasive article is proximate to and faces the first major surface of the third member, and

attaching the magnetic member of the second abrasive article to the third member by a magnetic force.

### EXAMPLES

A pad conditioner available under the trade designation 3M DIAMOND PAD CONDITIONER A165, from 3M Company, St. Paul, Minn., was placed on a hot plate with the metal carrier adjacent the hot plate surface. The pad conditioner had a 4 inch (10.2 cm) diameter, circular shaped, sintered abrasive plate bonded to a stainless steel carrier via a pressure sensitive adhesive. The pad conditioner was heated on the hot plate to lower the adhesive tack of the pressure sensitive adhesive which bonded the sintered abrasive plate to the stainless steel carrier. A putty knife was used to pry the sintered abrasive plate away from the stainless steel carrier. Remaining PSA that was adhered to the back of the sintered abrasive plate was removed by wiping with a cloth in combination with a solvent, isopropyl alcohol. The sintered abrasive plate was then washed and dried. A magnetic sheet, Flexible Rubber Magnet, product number NP12, available from Nihon Industrial Products Pte Ltd, Midview City, Singapore, was then laminated to one side of an acrylic adhesive transfer tape, 3M ADHESIVE TRANSFER TAPE DOUBLE LINERED 7962MP, available from 3M Company, after removing one liner of the transfer tape. The magnetic sheet with transfer tape was die cut into a 3.87 inch (9.83 cm) diameter, circular disc with two alignment holes, i.e. alignment cavities, 4.5 mm in diameter, producing a magnetic member. The alignment holes were located directly across from each other, along a line, with the center point of each located about 10 mm from the circumference of the magnetic sheet. The remaining release liner of the magnetic member was removed and the magnetic member was laminated to the non-abrasive, major surface of the sintered abrasive plate via the exposed acrylic adhesive, producing a first abrasive article. The center of the circular magnetic member coincided with the center of the circular sintered abrasive plate.

An 11 cm diameter, stainless steel carrier having a thickness of 6.86 mm was machined. The carrier was machined such that it contained a circular recess; having a diameter of about 10 cm and a depth of about 1.88 mm. The width of raised rim along the circumference of the carrier that defined the recess diameter was about 5 mm. The diameter and depth of the recess was designed such that the sintered abrasive plate with attached magnetic sheet would fit precisely within the recess, yet allow the abrasive portion of the sintered abrasive plate to protrude above the raised rim of the carrier. The carrier had two alignment pins, about 4.0 mm in diameter and located directly across from each other, along a line, with the center point of each located about 15 mm from the circumference of the carrier. The alignment pins were machined to precisely align with the alignment cavities of the magnetic sheet, such that, the alignment pins of the carrier would fit into the alignment cavities of the magnetic sheet, allowing a major surface of a magnetic sheet to lie flush with the major surface inside the carrier recess. The first abrasive article, i.e. the sintered abrasive plate with attached magnetic member, was mounted into the recess of the carrier by aligning the alignment cavities of the magnetic member of the first abrasive article with the alignment pins of the carrier and securing the exposed surface of the magnetic member to the carrier's major surface, defined by the recess region, through magnetic attachment between the magnetic member and the carrier, producing a second abrasive article. In this example, the carrier would be a third member. The carrier with magnetically attached abrasive member was held with the working surface of the abrasive member facing downward, so that the force of gravity acted on the magnetic member and abrasive member in a direction which may separate the abrasive member and magnetic member from the carrier. The abrasive member remained attached to the carrier via the magnetic member and corresponding magnetic force.

The carrier was fabricated with two release tabs located near the edge of the recessed region, each tab proximate to an alignment pin, although the specific location is not particularly limited. The release tabs, which had a length of about 5 mm and width of about 5 mm and a thickness equal to the carrier thickness in the recess area, were mounted into about 5 mm by about 7 mm rectangular tab holes cut into the carrier recess area through the thickness of the carrier. Each tab included a threaded hole, centered at approximately the midpoint of the thickness dimension and perpendicular thereto. The holes were located near one end of each tab. Each tab was attached to the carrier via a screw and corresponding threaded hole machined into the edge of the carrier that was the same diameter and thread size as the threaded hole of the tab, a given threaded hole of the carrier aligning with the threaded tab hole, allowing the screw to be mounted through the carrier edge and into the tab, thereby securing the tab to the carrier. In the “use” position (similar to FIG. 9A), the tabs fit into the tab holes of the recess area, below the major surface of the recess region and did not make contact with sintered abrasive plate with corresponding magnetic member. In this position, the first abrasive article was held securely to the carrier and could be used for an abrading application. In the “release” position (similar to FIG. 9B), which was achieved by turning the screws up to about 90 degrees, the tabs were urged into the magnetic member, forcing the magnetic member and attached sintered abrasive plate away from the surface of the recess region of the carrier. The edge of the sintered abrasive plate was then exposed over the raised rim of the carrier and was grasped, allowing the sintered abrasive plate and attached magnetic sheet to be removed from the carrier.

1. An abrasive article comprising:
an abrasive member having a working surface and an exterior attachment surface disposed opposite the working surface, wherein the abrasive member comprises a matrix material and an inorganic material having a Mohs hardness greater than about 7.0; and
a magnetic member having opposing first and second major surfaces;
wherein the first major surface of the magnetic member faces the exterior attachment surface; and
wherein the region of the abrasive article between the working surface of the abrasive member and first major surface of the magnetic member is free of a coupling structure that couples the abrasive member to the magnetic member by a magnetic force.

2. The abrasive article of claim 1, wherein the inorganic material comprises abrasive particles that are at least partially contained in a portion of the matrix material that is proximate the working surface.

3. The abrasive article of claim 1, wherein the inorganic material comprises an inorganic coating disposed on at least a portion of the matrix material that is proximate to the working surface.

4. The abrasive article of claim 1, wherein the inorganic material includes at least one of garnet, zirconia, spinel, zirconium silicate, chromium, silicon nitride, tantalum carbide, aluminum oxide, silicon carbide, tungsten carbide, titanium carbide, boron, boron nitride, boron carbide, rhenium diboride, titanium diboride, diamond, diamond like carbon, ultra-hard fullerite, rhenium diboride, and nanocrystaline diamond including aggregated diamond nanorods.

5. The abrasive article of claim 1, wherein the inorganic material includes at least one of diamond or diamond like carbon.

6. The abrasive article of claim 1, wherein the matrix material comprises a metal.

7. The abrasive article of claim 1, wherein the matrix material comprises a polymer.

8. The abrasive article of claim 1, wherein the matrix material comprises a ceramic.

9. The abrasive article of claim 8, wherein the ceramic comprises at least one of a green body ceramic and sintered ceramic.

10. The abrasive article of claim 1, wherein the working surface comprises a plurality of precisely shaped features.

11. The abrasive article of claim 1, further comprising an adhesive member interposed between and in contact with the exterior attachment surface of the abrasive member and the first major surface of the magnetic member, wherein the adhesive member couples the abrasive member to the magnetic member.

12. The abrasive article of claim 11, wherein the adhesive member comprises at least one of a pressure sensitive adhesive, a thermosetting adhesive and a heat activatable adhesive.

13. The abrasive article of claim 12, wherein the adhesive member comprises a pressure sensitive adhesive.

14. The abrasive article of claim 11, wherein the adhesive member comprises a thermosetting adhesive.

15. The abrasive article of claim 1, wherein the magnetic member includes at least one alignment cavity extending into the magnetic member.

16. The abrasive article of claim 1 further comprising at least one alignment pin, wherein the at least one alignment pin extends from the plane of the second major surface of the magnetic member.

17. The abrasive article of claim 1 further comprising a third member having a first major surface and a second major surface, wherein the first major surface of the third member faces the second major surface of the magnetic member and wherein the third member comprises a ferromagnetic material and is attached to the magnetic member by a magnetic force.

18. The abrasive article of claim 17, wherein the ferromagnetic material includes at least one of ferromagnetic steel and ferromagnetic stainless steel.

19. The abrasive article of claim 17, wherein the magnetic member includes at least one alignment cavity extending into the magnetic member.

20. The abrasive article of claim 19, wherein the third member further comprises at least one alignment pin and wherein each of the at least one alignment pin aligns with and extends into one of the at least one alignment cavity.

21. The abrasive article of claim 17 further comprising at least one alignment pin, wherein the at least one alignment pin extends from the plane of the second major surface of the magnetic member.

22. The abrasive article of claim 21, wherein the third member comprises at least one alignment cavity and wherein each of the at least one alignment pin extends into one of the at least one alignment cavity.

23. The abrasive article of claim wherein the abrasive article includes a release mechanism.

24. The abrasive article of claim 23, wherein the release mechanism includes one or more of at least one release tab, at least one release cavity and at least one release edge grove.

25. A method of separating an abrasive member from an abrasive article comprising:
providing an abrasive article according to claim 17, and
applying a separating force to at least one of the abrasive member, the magnetic member and the third member, wherein the separating force exceeds the magnetic force between the magnetic member and third member causing the abrasive member and attached magnetic member to separate from the third member.

26. A method of replacing the abrasive member of an abrasive article comprising:
providing an abrasive article according to claim 17,
applying a separating force to at least one of the abrasive member, the magnetic member and the third member, wherein the separating force exceeds the magnetic force between the magnetic member and third member causing the abrasive member and attached magnetic member to separate from the third member,
providing a second abrasive article according to claim 1,
positioning the second abrasive article such that the second major surface of the magnetic member of the second abrasive article is proximate to and faces the first major surface of the third member, and
attaching the magnetic member of the second abrasive article to the third member by a magnetic force.

27. An abrasive article comprising:
an abrasive member having a working surface and an exterior attachment surface disposed opposite the working surface, wherein the abrasive member comprises a matrix material and an inorganic material having a Mohs hardness greater than about 7.0; and
a magnetic member having opposing first and second major surfaces;
wherein the first major surface of the magnetic member faces the exterior attachment surface; and
an adhesive member interposed between and in contact with the exterior attachment surface of the abrasive member and the first major surface of the magnetic member, wherein the adhesive member couples the abrasive member to the magnetic member.

28. The abrasive article of claim 27 further comprising a third member having a first major surface and a second major surface, wherein the first major surface of the third member faces the second major surface of the magnetic member and wherein the third member comprises a ferromagnetic material and is attached to the magnetic member by a magnetic force.
